(19) United States
(12) Patent Application Publication
(10) Pub. No.: US 2007/0194641 A1
(43) Pub. Date: Aug. 23, 2007

(54) MOTOR

(75) Inventors: Tadayuki KANATANI, Minami-ku, Kyoto (JP); Satoshi UEDA, Minami-ku, Kyoto (JP)

Correspondence Address: NIDEC CORPORATION;c/o KEATING & BENNETT, LLP, 8180 GREENSBORO DRIVE, SUITE 850, MCLEAN, VA, 22102, US

(73) Assignee: NIDEC CORPORATION, Minami-ku (JP)

(21) Appl. No.: 11/677,108

(22) Filed: Feb. 21, 2007

(30) Foreign Application Priority Data
Feb. 22, 2006 (JP) 2006-046049

(51) Int. Cl. H02K 7/00; H02K 11/00

(52) U.S. Cl. 310/71; 310/90; 310/67 R

(57) ABSTRACT

A stator of a motor has a stator core and a wire wound around the stator core via an insulator. The wire is connected to an electric connection portion of a flexible printed circuit board arranged on an attachment plate of a housing. The flexible printed circuit board has an extension portion of a flexible substrate that extends to a cylindrical portion of the housing more than the electric connection portion. The extension portion has a collar portion functioning as an insulation sheet preventing contact between the lead wire of the coil and the housing.

### BACKGROUND OF THE INVENTION

1. Field of the Invention

The present invention generally relates to an insulation structure between a wire of a coil and a housing in a motor.

2. Description of the Related Art

The conventional structure of a motor for rotating a color wheel used for a single-chip DLP (Digital Light Processing) projector includes: a rotor magnet rotating around a predetermined rotary shaft; a stator radially facing the rotor magnet with a space provided therebetween; a housing having a cylindrical portion for holding the stator and an attachment portion arranged below the stator in a radially extending manner; and a flexible circuit board fixed to the housing. The flexible circuit board is used for connecting a wire of a coil of the stator to an external drive circuit (an exciting current supplying circuit for the coil).

FIG. 5 is a cross section view illustrating a schematic structure of a conventional motor. As illustrated in FIG. 5, the motor includes a rotor magnet 104 and a stator 105 radially facing the rotor magnet 104. The stator includes a stator core 106 and a coil 107 defined by a wire 107a wound around the stator core 106. A flexible printed circuit board (FPC) 117 adheres to the top surface of an attachment plate 112. The wire 107a of the coil 107 is electrically connected to the conductive pattern of the FPC 117 by soldering. The wire 107a is connected to an external drive circuit (an exciting current supplying circuit for the coil) via the FPC 117.

An insulating sheet 119 for preventing the wire 107a from contacting a bushing 111 is attached to the bushing 111. The insulating sheet 119 is obtained by punching a PET (polyethylene terephthalate) sheet into an annular shape. In the conventional structure, however, the insulating sheet 119 may be deformed due to the heat of soldering for connecting the wire 107a to the FPC 117. There is consequently the possibility that the insulating sheet 119 does not sufficiently perform the function of an insulating sheet.

In addition, the number of components to be provided in the motor, as well as the difficulty of the assembly process, is increased by providing the insulating sheet 119. Thus, manufacturing cost of the motor increases.

### BRIEF SUMMARY OF THE INVENTION

In order to overcome the problems described above, a motor according to preferred embodiments of the present invention includes a housing having a cylindrical portion and an attachment portion, a stator fixed to an outer peripheral surface of the cylindrical portion, and a flexible printed circuit board adhering to the top surface of the attachment portion. The stator has a stator core that is preferably obtained by stacking magnetic steel plates and a coil wound around the stator core via an insulator. The coil has a wire connected to the flexible printed circuit board. In particular, preferred embodiments of the present invention provide a structure that reliably prevents contact between the wire of the coil and the housing by the flexible printed circuit board.

The flexible printed circuit board according to preferred embodiments of the present invention has a flexible substrate, a plurality of conductive patterns disposed on the substrate, and an electric connection portion connected to the wire of the coil. An extension portion that extends from the electric connection portion toward the cylindrical portion is provided. The extension portion has a collar portion functioning as an insulating sheet that prevents contact between the wire of the coil and the housing.

Other features, elements, processes, steps, characteristics and advantages of the present invention will become more apparent from the following detailed description of preferred embodiments of the present invention with reference to the attached drawings.

### BRIEF DESCRIPTION OF THE DRAWINGS

FIG. 1A is a cross section view illustrating a schematic structure of a motor according to a first preferred embodiment of the present invention.

FIG. 1B is a magnified view illustrating a portion where a bushing and an attachment plate are joined.

FIG. 2A is a plan view illustrating example of the shape of a flexible printed circuit board in the motor according to the first preferred embodiment of the present invention.

FIG. 2B is a plan view illustrating another example of the shape of a flexible printed circuit board in the motor according to the first preferred embodiment of the present invention.

FIG. 2C is a plan view illustrating yet another example of the shape of a flexible printed circuit board in the motor according to the first preferred embodiment of the present invention.

FIG. 3 is a cross sectional view illustrating a schematic structure of a motor according to a second preferred embodiment of the present invention.

FIG. 4 is a plan view illustrating an example of the shape of the flexible printed circuit board in the motor according to the second preferred embodiment of the present invention.

FIG. 5 is a cross sectional view illustrating a schematic structure of a motor according to the conventional technique.

### DETAILED DESCRIPTION OF THE PREFERRED EMBODIMENTS

Preferred embodiments of the present invention will be described with reference to attached drawings. When a positional relation or a direction of each member is described by using “up” and “down” in the following description, it refers to the positional relation or direction in the diagram, not a positional relation or direction of the member assembled in an actual device.

First Preferred Embodiment

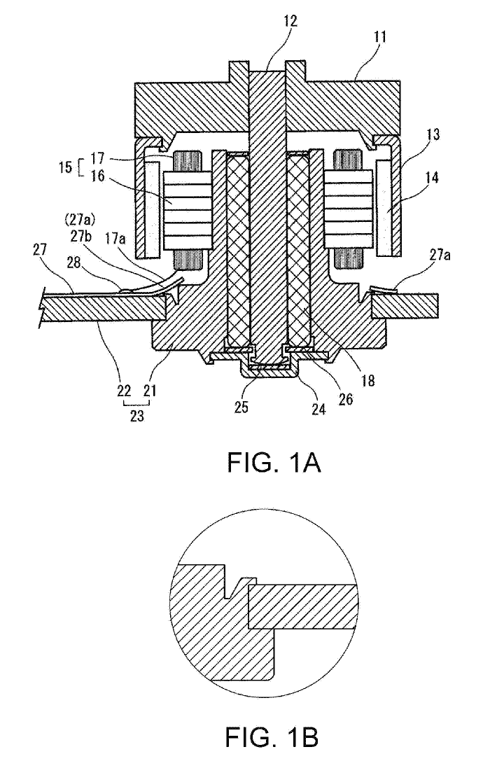

FIG. 1A is a cross sectional view illustrating a schematic structure of a motor according to a first preferred embodiment of the present invention. The motor is preferably used for rotating a color wheel of a single-chip DLP projector, for example. In the motor, a shaft 12 is fixed in the center of a rotor hub 11. The rotor hub 11 preferably is made of an aluminum material and a color wheel is fixedly mounted thereon. A rotor yoke 13 having a substantially hollow cylindrical shape is fixed to the peripheral portion of the under surface of the rotor hub 11. A rotor magnet 14 having a hollow, substantially cylindrical shape 14 is fixed to the inner peripheral surface of the rotor yoke 13. A stator 15 is arranged so as to face the rotor magnet 14 with a space defined therebetween. The stator 15 is fixed to the outer peripheral surface of a bushing 21.

The bushing 21 preferably has a substantially cylindrical shape. The lower portion of the bushing 21 is fitted and fixed in an opening in an attachment plate (i.e., attachment portion) 22. A housing 23 is defined by the bushing 21 and the attachment plate 22. The stator 15 fixed to the outer peripheral surface of the bushing 21 has a stator core 16 that is preferably formed by laminating a plurality of magnetic steel plates, and a coil 17 wound around the stator core 16 in a plurality of positions (i.e., a plurality of poles) via a insulator such as a resin mold for insulation or a coating for insulation (not shown in Figs).

A lower end opening of the bushing 21 is closed by attaching a cap 24, at a middle of which a plastic or resin plate 25 defining a thrust bearing is arranged, to support the bottom surface of the shaft 12. A ring-shaped retaining member 26 is arranged axially between a lower end surface of the sleeve 15 and an upper surface of the cap 24. A radially inner end portion of the retaining member 26 is arranged in a circumferential annular groove arranged at a bottom portion of the shaft 12.

A flexible printed circuit board (FPC) 27 adheres to the top surface of the attachment plate 22 of the housing 23. A top surface of the FPC 27 is preferably made of polyimide resin film on which a conductive pattern is arranged. In the first preferred embodiment of the present invention, the conductive pattern is preferably arranged on the top surface of the FPC 27, and the under surface of the FPC 27 adheres to the top surface of the attachment plate 22.

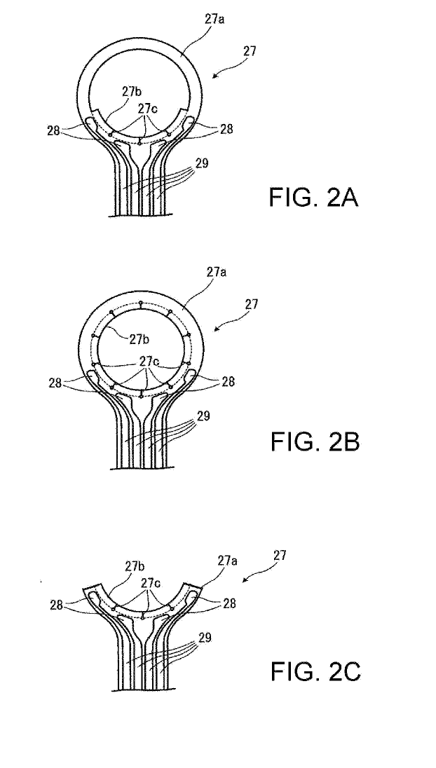

FIGS. 2A and 2B are top plan views illustrating the FPC 27 according to the first preferred embodiment of the present invention. The FPC 27 is preferably formed by an elastic substrate and conductive patterns formed thereon. On the top surface of the FPC 27, conductive patterns 29 and electric connection portions 28 arranged at ends of the conductive patterns 29 are provided. The electric connection portion 28 is a soldering land for electrically connecting the wire 17a of the coil 17 and the conductive pattern 29. The wire 17a of the coil 17 is soldered to and electrically connected to the conductive pattern on the flexible printed circuit board 27 at the electric connection portion 28. Thus, the coil 17 is connected to an external drive circuit (an exciting current supplying circuit for the coil) via the flexible printed circuit board 27. In the motor according to the first preferred embodiment of the present invention, a plurality of coils 17 are connected in a star configuration (Y configuration), and the motor 1 is driven by a three phase current. In the conductive patterns 29, four patterns of a “u” phase, a “v” phase, a “w” phase, and a neutral point are provided. The wires 17a led from the coils 17 are similarly four lines of the “u” phase, “v” phase, “w” phase, and the neutral point.

As shown in FIGS. 1, 2A and 2B, the FPC 27 has an extension portion 27a where the substrate of the FPC 27 extends circumferentially around the bushing 21 (the cylindrical portion of the housing 23). As illustrated in FIG. 2A, the extension portion 27a of the FPC 27 has an annular shape surrounding the bushing 21 in the circumferential direction. The extension portion 27a includes a collar portion 27b where the substrate extends in the radially inward direction. The collar portion 27b functions as an insulating sheet for preventing the wire 17a of the coil 17 from connecting the bushing 21 and/or the attachment portion 22. The collar portion 27b includes a plurality (e.g, three in this preferred embodiment) of slits 27c extending from the inner rim of the collar portion 27b toward the radially outward direction such that the collar portion 27b is easily bent in the axial direction. Radially outermost sides of the slits 27c are connected to through holes having greater circumferential width than that of the slits 27c. In the present preferred embodiment of the present invention, the through holes have a substantially circular shape. The plurality of slits 27c and the through holes allow the collar portion 27b to be bent more easily in the axial direction.

As illustrated in FIG. 2B, the collar portion 27b may be provided in the entire inner rim of the annular-shaped extension portion 27a. In this case as well, by providing the plurality of slits 27c and through holes to which the slits 27c are connected, the collar portion 27b will be bent in the axial direction.

As illustrated in FIG. 2C, the extension portion 27a may be formed to have an arc shape, and the collar portion 27b may have an arc shape as well. In this case as well, by providing the plurality of slits 27c and through holes to which the slits 27c are connected, the collar portion 27b will be bent in the axial direction.

FIG. 1B is a magnified view illustrating a joint portion where the bushing 21 and the attachment plate 22 are joined together. The bushing 21 includes a convex portion axially protruding from a top surface of the attachment plate 22 at the joint portion. The convex portion is deformed such that the attachment plate 22 are axially clumped and fixed to the bushing 21.

As shown in FIG. 1A, the annular-shaped extension portion 27a is arranged between the stator 15 and the housing 23 defined by the bushing 21 and the attachment plate 22, and an inner rim of the collar portion 27b is arranged to extend radially inwardly from positions where the wires 17a are led out from the coil 17. Through the configuration depicted above, the wire 17a of the coil 17 is prevented from contacting the housing 23. Further, the collar portion 27b is arranged to cover the joint portion between the bushing 21 and the attachment plate 22. Through the configuration mentioned above, the wire 17a of the coil 17 is prevented from contacting between the corner of the bushing 21 in the joint portion between the bushing 21 and the attachment plate 22. Each of the slits 27c preferably radially extends between the conductive patterns 29. Through the configuration described above, the collar portion 27b is bent in a position corresponding to each of the wires 17a, so that the wire 17a is prevented from contacting the housing 23.

The substrate of the FPC 27 is preferably made of a polyimide resin film having excellent heat resistance. Thus, the FPC 27 does not deform due to the heat generated when the wire 17a is soldered to the electric connection portion 28. As a result, the extension portion 27a including the collar portion 27b of the FPC 27 prevents the wire 17a of the coil 17 from contacting the bushing 21 and/or the attachment plate 22.

Second Preferred Embodiment

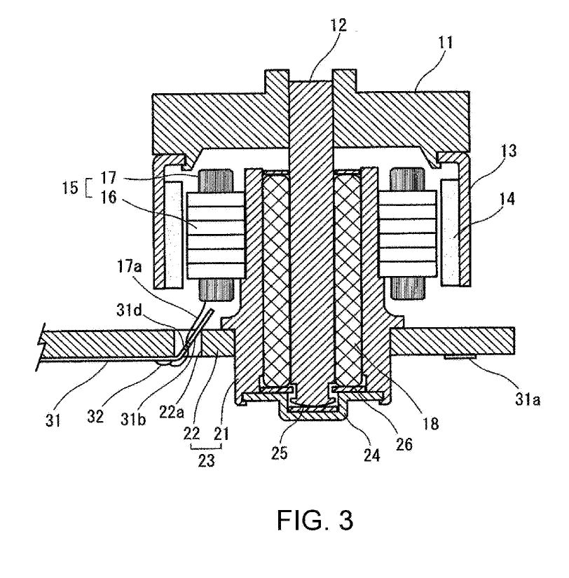

FIG. 3 is a cross sectional view illustrating a schematic structure of a motor according to a second preferred embodiment of the present invention. In the foregoing first preferred embodiment, the bushing 21 is inserted in the attachment plate 22 from the underside of the attachment plate 22 and fitted therein. Then, the FPC 27 adheres on the top surface of the attachment plate 22. In the second preferred embodiment of the present invention, the bushing 21 is inserted in the attachment plate 22 from upside and fitted therein. Then a flexible printed circuit board 31 (hereinafter simply referred to as a FPC 31) adheres to the under surface of the attachment plate 22. Configurations and functions of other members are substantially the same as those already described in the first preferred embodiment of the present invention shown.

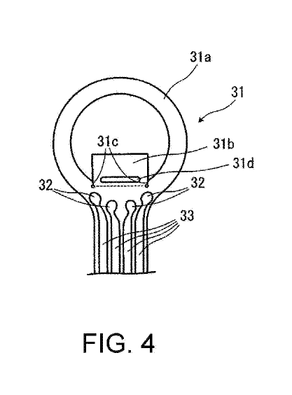

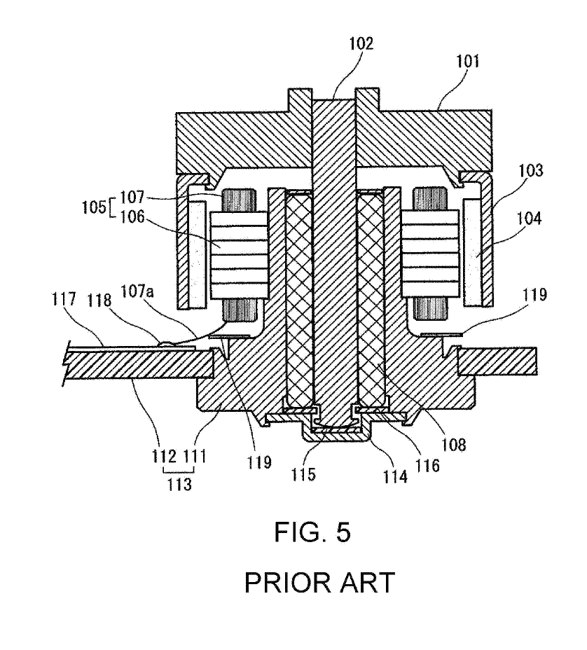

FIG. 4 is a plan view illustrating the FPC 31 according to the second preferred embodiment of the present invention. In a manner similar to the FPC 27 according to the first preferred embodiment of the present invention illustrated in FIG. 2A, conductive patterns 33 and electric connection portions 32 arranged at the ends of the conductive patterns 33 are provided on the top surface of the FPC 31. The FPC 31 also has an annular extension portion 31a where a substrate of the FPC 31 extends circumferentially around the bushing 21 which is the substantially cylindrical portion of the housing 23.

The extension portion 31a has a relatively long collar portion 31b where a portion of the inner rim of the annular extension portion 31a extends toward the center. Slits 31c extending outwardly in the extension portion 31a are arranged on both circumferential sides of the base portion of the collar portion 31b, and the collar portion 31b is bent at a portion indicated by a broken line. An opening 31d for passing the wire 17a of the coil 17 is arranged in a portion of collar portion 31d near from where the collar portion 31d is bent.

In the second preferred embodiment of the present invention as illustrated in FIG. 3, the conductive patterns are arranged on the under surface of the FPC 31, while the top surface of the FPC adheres to the under surface of the attachment plate 22. The attachment plate 22 includes an opening 22a arranged such that the wire 17a of the coil 17 and the collar portion 31b of the flexible printed circuit board 31 pass through. The collar portion 31b of the FPC 31 passes the attachment plate 22 from the bottom side to the upper side through the opening 22a of the attachment plate 22, and upwardly extends toward the bushing 21. In a manner similar to the first preferred embodiment of the present invention, the collar portion 31b functions as an insulation sheet for preventing the wire 17a of the coil 17 from contacting the bushing 21 and/or the attachment plate 22.

The wire 17a of the coil 17 downwardly extends from the coil 17 to the FPC 31 and along the top surface of the collar portion 31b of the FPC 31. Then, the wire 17a passes through the opening 31d arranged in the collar portion 31b to the under surface of the collar portion 31b, and is led along the under surface of the collar portion 31b to the electric connection portion 32. The wire 17a of the coil 17 is connected to the conductive pattern preferably by soldering at the electric connection portion 32 in the FPC 31.

In the second preferred embodiment of the present invention, the substrate of the FPC 31 is preferably made of a polyimide resin film having excellent heat resistance. Thus, the FPC 31 does not deform due to the heat generated when the wire 17a is soldered to the electric connection portion 28. As a result, the extension portion 27a including the collar portion 31b of the FPC 31 prevents the wire 17a of the coil 17 from contacting the bushing 21 and/or the attachment plate 22.

While preferred embodiments of the present invention have been described above, it is to be understood that variations and modifications will be apparent to those skilled in the art without departing the scope and spirit of the present invention. The present invention relates to a structure for preventing short-circuit or poor insulation caused by unnecessary contact of a wire of a coil and a metal housing defined by a bushing and an attachment plate. The structures of a rotor, a stator, a bearing, and the like are not limited to those of the foregoing embodiments. The shapes of the extension portion and the collar portion of the flexible printed circuit board are not limited to those shown in the diagrams but can be properly modified. The materials, shapes, assembling methods, and the like of the members are not also limited. The scope of the present invention, therefore, is to be determined solely by the following claims.

What is claimed is:

1. A motor comprising:
a stator including a stator core and a wire wound around the stator core;
a rotor arranged to rotate relative to the stator with a center axis as a rotational center;
a housing including a bushing having a substantially cylindrical shape and an attachment plate joined together;
a circuit board arranged on the housing, and including an elastic substrate and an electric connection portion to which an end of the wire is connected;
a collar portion that is integral with the elastic substrate and covers a portion where the bushing and the attachment plate are joined; wherein
the collar portion insulates the wire from the housing.

2. The motor according to claim 1, wherein the circuit board has an extension portion that is integral with the substrate and has an inner rim circumferentially surrounding the bushing.

3. The motor according to claim 2, wherein the collar portion extends radially inwardly, has an inner periphery surrounding the bushing and covers substantially an entire portion where the bushing and the attachment plate are joined.

4. The motor according to claim 3, wherein the collar portion includes at least one slit extending from an inner periphery of the collar portion in a radially outward direction.

5. The motor according to claim 4, wherein the circuit board includes a plurality of electric connection portions and a plurality of the slits, each of the plurality of slits radially extends between the conductive patterns that are circumferentially adjacent to each other.

6. The motor according to claim 4, wherein the circuit board includes a through hole to which the at least one slit extends, and the through hole is larger than the at least one slit in a circumferential direction centered on the center axis.

7. The motor according to claim 4, wherein an inner periphery of the collar portion is arranged to extend radially inwardly from a portion where the wire is led from the stator core to the electric connection portion.

8. The motor according to claim 1, wherein the collar portion has an arc shape along an outside periphery of the bush.

9. The motor according to claim 1, wherein the collar portion includes at least one slit extending from an inner periphery of the collar portion in a radially outward direction.

10. The motor according to claim 9, wherein the circuit board includes a plurality of electric connection portions and a plurality of the slits, each of the plurality of slits radially extends between the conductive patterns that are circumferentially adjacent to each other.

11. The motor according to claim 9, wherein the circuit board includes a through hole to which the at least one slit extends, and the through hole is larger than the at least one slit in a circumferential direction centered on the center axis.

12. The motor according to claim 1, wherein an inner periphery of the collar portion is arranged to extend radially inwardly from a portion where the wire is led from the stator core to the electric connection portion.

13. The motor according to claim 1, wherein the bushing includes a convex portion which axially protrudes from a top surface of the attachment plate at a portion where the bushing and the attachment plate are joined, the convex portion is deformed such that the attachment plate is axially clamped between a portion of the bushing and the convex portion,
the circuit board is fixed to the top surface of the attachment plate, and
the collar portion covers at least a portion of the area of the convex portion that is deformed.

14. The motor according to claim 1, wherein the elastic substrate is made of heat-resistant material.

15. The motor according to claim 14, the heat-resistant material is one of polyethylene terephthalate resin and polyimide resin.

16. A motor comprising:
a stator including a stator core and a wire wound around the stator core;
a rotor arranged to rotate relative to the stator with a center axis as a center;
a housing including a bushing and an attachment plate joined together, the attachment plate includes an opening axially penetrating therethrough;
a circuit board arranged on a bottom surface of the housing, and including a elastic substrate and an electric connection portion to which one end of the wire is connected; and
a collar portion that is integral with an elastic substrate, and including an insertion portion which is inserted into the opening to cover a portion of an upper periphery of the opening and a through hole in which the wire is inserted; wherein
the collar portion insulates the wire from the housing.
